(19) United States
(12) Patent Application Publication
(10) Pub. No.: US 2006/0023037 A1
(43) Pub. Date: Feb. 2, 2006

(54) Clamping device for ink cartridges

(75) Inventors: Carl W. Holland, Webster, NY (US); William A. Putman, Franklin, TN (US); William F. Schumacher, Pittsford, NY (US)

Correspondence Address: JAMES W. McKEE;Fay, Sharpe, Fagan, Minnich & McKee, LLP, 7th Floor, 1100 Superior Avenue, Cleveland, OH, 44114-2579, US

(73) Assignee: Nu-kote International, Inc. a corporation of Delaware

(21) Appl. No.: 10/902,726

(22) Filed: Jul. 30, 2004

(51) Int. Cl. B41J 2/175

(52) U.S. Cl. 347/85

(57) ABSTRACT

An ink cartridge for insertion into a cartridge holder has an ink supply tube coupled therewith for delivering ink to the cartridge from a remote source, and a clamping device on said cartridge is operable to open the supply tube when the cartridge is introduced into the holder and to close the tube when the cartridge is removed from the holder.

### BACKGROUND OF THE INVENTION

The present invention relates to the art of ink cartridges for ink jet printers and, more particularly, to improved clamping devices for opening and closing an ink supply line to an ink cartridge in a continuous ink supply system.

Continuous ink refill systems for disposable ink jet cartridges are of course well known as shown, for example, in U.S. Pat. No. 5,469,201 to Erickson, et al. In such systems, basically, a cartridge is connected to an auxiliary ink supply reservoir by means of a flexible hose or tube, and during operation of the printing system the tube is open to allow ink to flow from the auxiliary reservoir to the ink cartridge. During shipment or handling of the ink supply reservoir system when it is outside the printing machine, the supply tube must be closed to prevent the transfer of ink from the reservoir to the cartridge. Moreover, after installation in the printer, cleaning of the printer and/or the ink delivery system requires removal of the cartridge from the printer. In connection therewith, changes in the cartridge position relative to the supply reservoir, and/or pressure on the latter, will cause the ink delivery system to lose its prime and fail. Clamping the supply tube to close the flow of ink therethrough from the reservoir to the cartridge during cleaning, or removal for any purpose, isolates the volume of ink in the reservoir so as to prevent such failure.

Heretofore, closing of the delivery tube has been achieved such as by the use of a manually operated pinch clamp as shown, for example, in U.S. Pat. No. 5,745,137 to Scheffelin, et al., or a manually operated stopcock as shown for example in the aforementioned patent to Erickson, et al. The use of such devices for closing the flow of ink through the delivery tube not only requires the manual actuation of the device by the operator but also requires that the operator remember to open and close the device and, especially, to close the device before removal of the cartridge from the printer.

### SUMMARY OF THE INVENTION

In accordance with the present invention, a clamping device is associated with an ink cartridge so as to automatically open and close the ink supply tube to the cartridge in response, respectively, to introducing and removing the cartridge from a cartridge holder of a printer. Such automatic clamping and unclamping of the supply tube advantageously eliminates the concern for an operator having to remember to manually actuate a valve mechanism to open and close the supply tube upon insertion and removal of the cartridge from the printer. Further, such automatic opening and closing of the supply tube provides added stability to the ink supply system and security against leakage of ink to the cartridge during shipping, installation and cartridge cleaning operations.

The clamping device may include component parts integral with a cartridge, or it may be an assembly of component parts mountable on a cartridge as a unit. As will become apparent hereinafter, clamping components of the clamping device are relatively displaced upon insertion of the cartridge into a cartridge holder to open the supply tube to the flow of ink therethrough from the reservoir to the cartridge. Likewise, the component parts are relatively displaced upon removable of the cartridge from the cartridge holder to close the supply tube to the flow of ink therethrough.

It is accordingly an outstanding object of the present invention to provide improvements in connection with controlling the flow of ink from a reservoir to an ink cartridge in a continuous ink supply system.

Another object is the provision of a clamping device operable to automatically open and close an ink supply tube to a cartridge respectively in response to introducing and removing the cartridge from a printer.

A further object is the provision of a clamping device of the foregoing character which is structurally associated with an ink cartridge so as to be automatically operable in connection with inserting and removing the cartridge from a printer to respectively open and close the ink supply line to the cartridge.

### BRIEF DESCRIPTION OF THE DRAWINGS

The foregoing objects, and others, will in part be obvious and in part pointed out more fully hereinafter in conjunction with the written description of preferred embodiments of the invention illustrated in the accompanying drawings in which:

FIG. 1 is a perspective view of an ink cartridge having a clamping device in accordance with the present invention mounted thereon;

FIG. 2 is a side elevation view of the ink cartridge in FIG. 1 with the clamping device removed;

FIG. 3 is an inverted perspective view of the clamping device shown in FIG. 1;

FIG. 4 is a sectional elevation view of a portion of the clamping device and somewhat schematically illustrates the clamping device in the open condition thereof;

FIG. 5 is a sectional elevation view similar to FIG. 4 and illustrating the clamping device in the closed condition thereof;

FIG. 6 is a perspective view of the ink cartridge and clamping device mounted in a cartridge holder;

FIG. 7 is a side elevation view of another embodiment of a clamping device in accordance with the present invention, mounted on a cartridge;

FIG. 8 is an elevation view of the reversed side of the clamping device;

FIG. 9 is an elevation view of the inside of the base component of the clamping device;

FIG. 10 is an elevation view of the inside of the slide component of the clamping device;

FIG. 11 is an enlarged cross-sectional view of the clamping device taken along line 11-11 in FIG. 7;

FIG. 12 is a side elevation view of yet another embodiment of the clamping device in accordance with the invention, mounted on an ink cartridge;

FIG. 13 is an elevation view of the inside of the base component of the clamping device;

FIG. 14 is an elevation view of the inside of the slide component of the clamping device; and,

FIG. 15 is an enlarged cross-sectional view of the clamping device taken along line 15-15 in FIG. 12.

### DESCRIPTION OF PREFERRED EMBODIMENTS

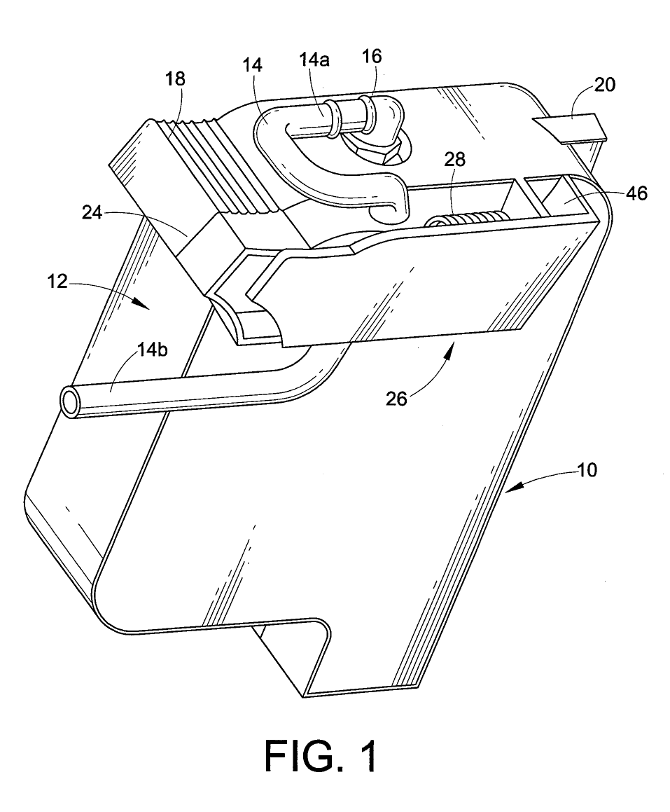

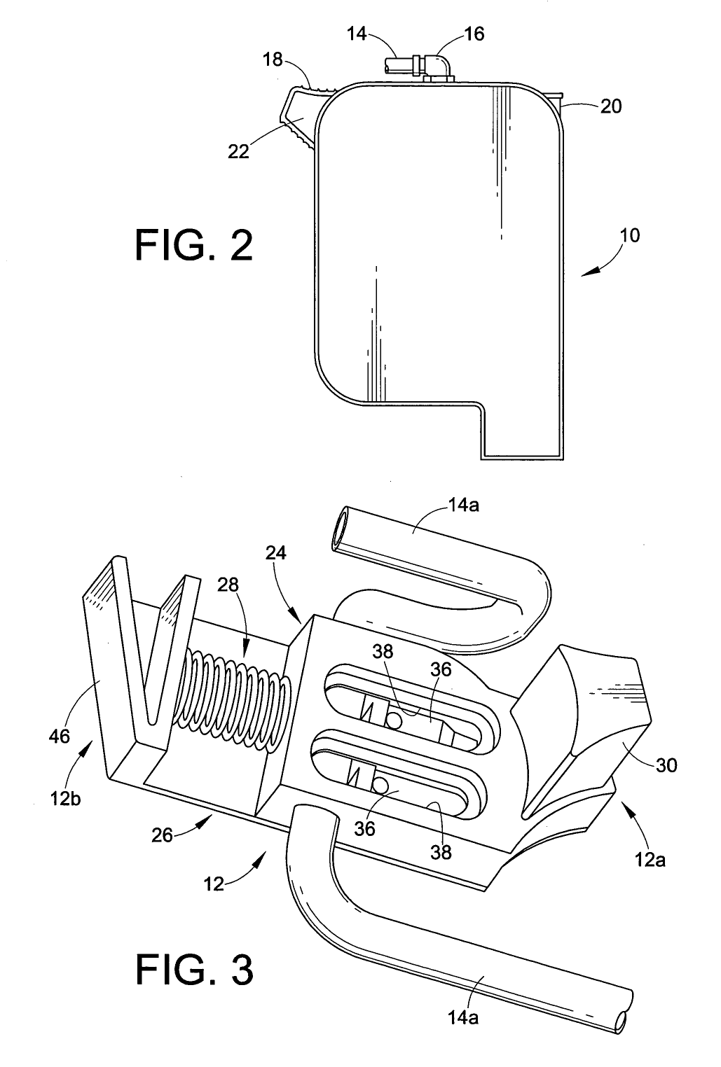

Referring now in greater detail to the drawings, wherein the showings are for the purpose of illustrating preferred embodiments of the invention only, and not for the purpose of limiting the invention, FIG. 1 illustrates an ink cartridge 10 having a clamping device 12 in accordance with the present invention mounted thereon for controlling the flow of ink to the cartridge from a remote ink reservoir, not shown. More particularly in this respect, a flexible ink supply tube 14 has an end 14a for attachment to the cartridge, such as by a coupling 16, and has an end 14b leading from the cartridge to the remotely located ink reservoir, such as a collapsible bag. As best seen in FIG. 2, cartridge 10 has front and rear walls 10a and 10b, respectively, a top wall 10c and a bottom wall 10d. Further, the cartridge has a handle 18 at the juncture between rear wall 10b and top wall 10c which, as is well known, facilitates introducing and removing the cartridge relative to a cartridge holder in a printer. A latching component 20 at the juncture between top wall 10c and front wall 10a provides for releasably interengaging the cartridge with the holder. Handle 18 has a laterally inwardly extending recess 22 which, as will become apparent hereinafter, is cooperable with a mounting protrusion on clamping device 12 for mounting the latter on the cartridge.

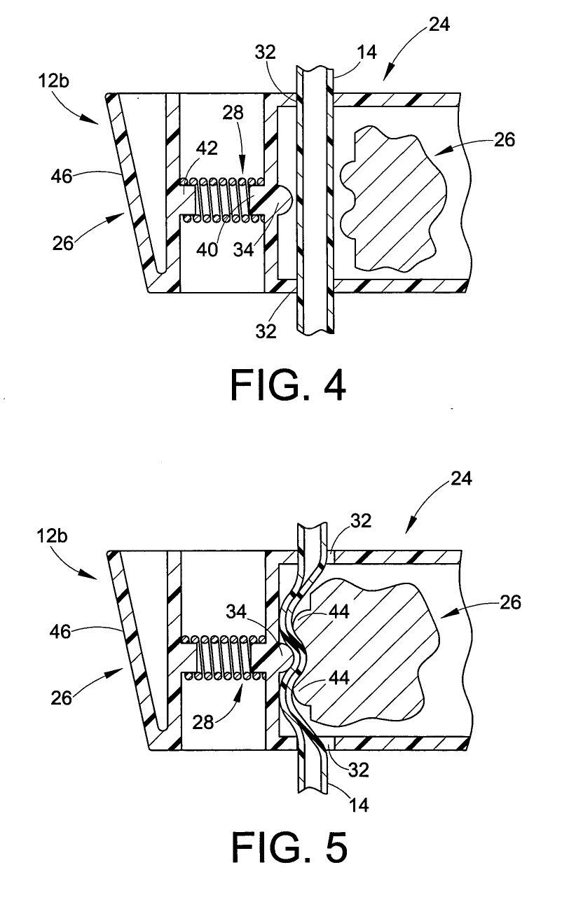

Referring now to FIGS. 1, 3, 4, and 5 of the drawing, clamping device 12 in this embodiment is a unit independent of the cartridge and comprises a base component 24, a slide component 26, and a biasing spring 28 between the base and slide components. Base component 24, includes an end 29 corresponding in contour with cartridge handle 18 and including a mounting protrusion 30 which is profiled to be received in recess 22 of cartridge handle 18 to securely attach the clamping device to the cartridge. The base component further includes a pair of openings 32 through which supply tube 14 extends, and the base component is provided with a half round boss 34 between the openings. Clamping device 12 has opposite ends 12a and 12b, and mounting protrusion 30 is on the base at end 12a. Slide component 26 is interengaged with base component 24 for sliding displacement relative thereto in the direction between ends 12a and 12b. More particularly in this respect, the slide component has a pair of protrusions 36 received in elongated slots 38 in the base component and receiving screws 39 which slidably engage slot shoulders 38a to retain the base and slide in assembled relationship. The end of slide 26 at end 12a of the clamping device is also profiled to correspond in contour with cartridge handle 18. Spring 28 is interposed between a mounting post 40 on the base component and a mounting post 42 on the slide component and biases the latter to the left in FIGS. 4 and 5 relative to the base component. The slide component further includes a pair of half round bosses 44 which cooperate with boss 34 on the base component to provide a pinch point for closing supply tube 14, as shown in FIG. 5. In this respect, and as will be explained more fully hereinafter, when clamping device 12 is mounted on a cartridge and the base and slide components are in the positions shown in FIG. 4, the cartridge is mounted in a printer and the bosses are separated for the tubing to be open to the flow of ink therethrough to the cartridge. When the base and slide components are in the positions shown in FIG. 5, the cartridge is outside the printer and the components are biased by spring 28 for bosses 34 and 44 to clampingly engage supply tube 14 therebetween to close the tube to the flow of ink from the reservoir to the cartridge. In this embodiment, the end of slide component 26 which provides end 12b of the clamping device includes a slide actuating wall member 46 which, as will become apparent hereinafter, interengages with a wall component on a cartridge holder of an ink printer to actuate the slide from the closed to the open condition of supply tube 14 in response to inserting the cartridge into the holder.

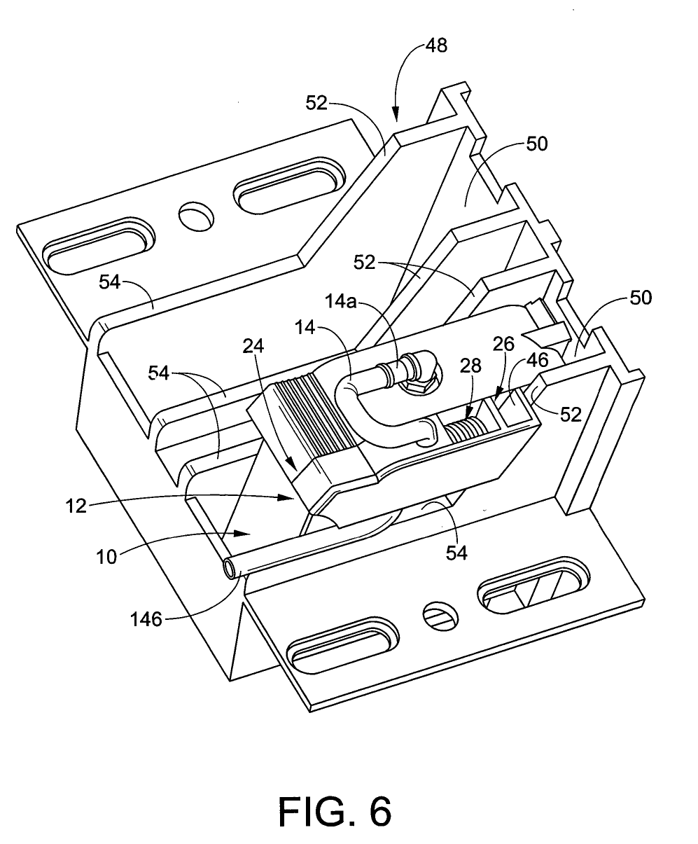

Referring now to FIG. 6, an ink cartridge holder 48 of a printer includes pockets 50 for receiving ink cartridges, and the latter pockets include vertically inclined walls 52 adjacent the printing head end of the cartridge and horizontal walls 54 extending from the lower ends of walls 52 toward the opposite end of the cartridge. When the cartridge and clamping device 10 mounted thereon are outside the printer, the component parts thereof are in the positions shown in FIGS. 1 and 5, whereby the ink supply tube is closed. When the cartridge is introduced into the holder, wall 46 of the slide component engages against wall 52 of cartridge holder 48 whereby, as the cartridge is fully inserted into the holder, the component parts are displaced to the positions shown in FIGS. 4 and 6 against the bias of spring 28 to open the ink supply tube 14 to the flow of ink from the reservoir to the cartridge. It will be appreciated from the foregoing description that when the cartridge is removed from the holder, wall 46 of slide component 26 disengages from wall 52 of the cartridge holder, whereupon spring 28 displaces the slide relative to the base component and to the positions thereof shown in FIGS. 1 and 5 to again close the supply tube to the flow of ink therethrough.

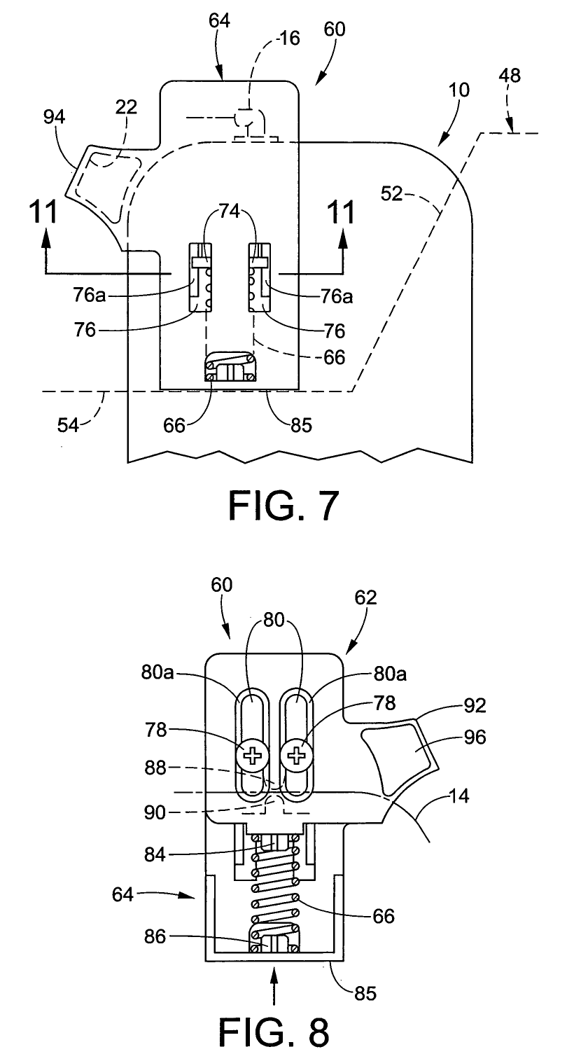

FIGS. 7-11 illustrate another embodiment of a clamping device in according with the present invention. In this embodiment, a clamping device, which is designated by the numeral 60, comprises a base component 62, a slide component 64 and a biasing spring 66 interposed therebetween for the purpose set forth hereinafter. Base 62 and slide 64 are slidably interengaged in part by a pair of bars 68 on the inner side of base component 62 and a plurality of bars 70 on the inner side of slide component 64 and which are spaced apart to define channels 72 therebetween for slidably receiving bars 68 on the base component. The base and slide components are further slidably interengaged by a pair of fingers 74 on the base which, during assembly of the base and slide, are insertable through the enlarged lower ends of L-shaped slots 76 in the slide and then moved into the upper ends of the slots for the fingers to overlie and slidably engage shoulders 76a of the slots. During such interengagement, bars 68 are slidably received in channels 72, and the slide and base are then interconnected against separation by a pair of screws 78 extending through corresponding slots 80 in the base and into openings therefor, not designated numerically, in a mounting post 82 on the slide. The heads of these screws overlie shoulders 80a of the slots to maintain the base and slide against separation axially with respect to the screw axes, and it will be appreciated that the length of slots 80 accommodates the desired relative displacement capability between the base and slide in the direction of the slots.

The bottom wall of base 62 is provided with a downwardly extending post 84 and bottom wall 85 of slide 64 is provided with an upwardly extending post 86. The opposite ends of spring 66 receive the corresponding one of the posts 84 and 86 and is in compression so as to bias the base and slide components away from one another in the direction of slots 80. Further, slide 64 includes a rounded boss 88 extending downwardly from mounting post 82, and the bottom wall of base 62 includes a rounded boss 90 extending upwardly therefrom. As set forth hereinafter, bosses 88 and 90 are aligned for displacement between clamping and unclamping positions relative to supply tube 14 and in response to relative displacement between the base and slide components.

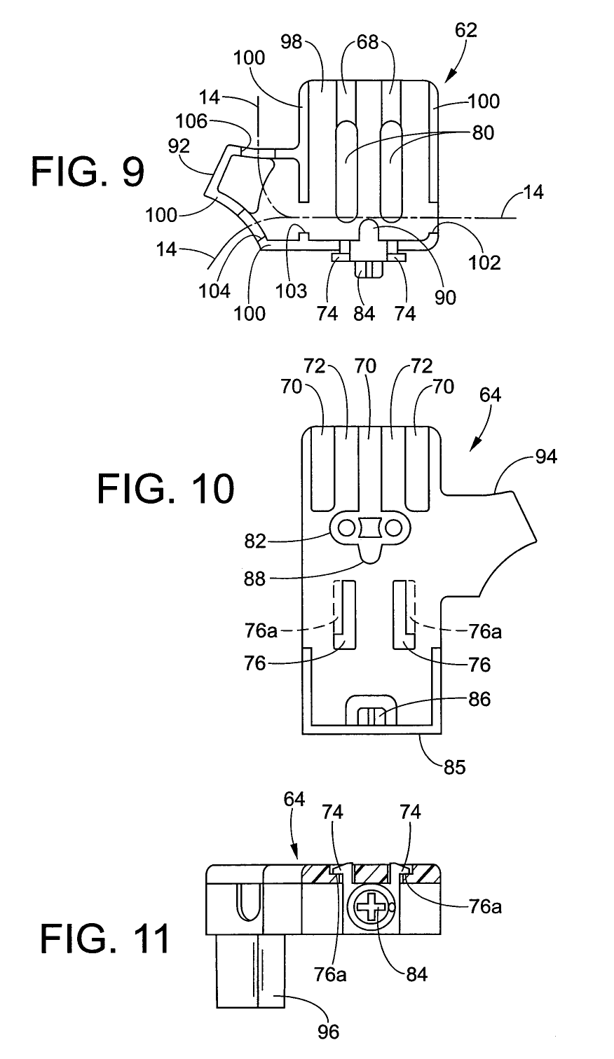

Base 62 and slide 64 have extensions 92 and 94, respectively, extending from one side thereof and in overlying relationship when the component parts are in the positions shown in FIGS. 7 and 8. Extensions 92 and 94 correspond in contour with the handle 18 of cartridge 10 on which the clamping device is mounted by means of a mounting protrusion 96 on extending 92 of base 62 and which is profiled to be received in recess 22 of the cartridge handle as in the previous embodiment. As will be appreciated from FIG. 9, the inside of base component 62 is defined in part by a planar wall 98 and a peripheral wall 100 extending inwardly therefrom and along the sides, bottom and extension 92. Wall 100 is provided with openings 102, 103, 104, and 106 for receiving supply tube 14 and which openings provide for selective routing of the tubing relative to the clamping device, cartridge and ink supply reservoir. In this respect, as shown in FIG. 9, openings 102, 103 and 104 provide for routing the tubing linearly through the clamping device at a location adjacent the lower end of the cartridge handle, and openings 102, 103 and 106 provide for routing the tubing horizontally into the clamping device and thence upwardly through extension 92. In either event, it will be appreciated that the tubing has one end routed for connection to coupling 16 on a cartridge and the other end routed to the ink reservoir.

It will be noted in this embodiment, as seen in FIG. 7, that the orientation of the base and slide components and protrusion 96 is such that when the clamping device is mounted on cartridge 10, the slide component is displaceable vertically relative to the base component as opposed to horizontally as in the previous embodiment. When the component parts are assembled and in the positions thereof shown in FIG. 8, spring 66 biases slide component 64 downwardly relative to base 62, whereby tube 14 is pinched between bosses 88 and 90 to close the tube against flow of ink therethrough. As in the previous embodiment, this is also the position of the clamping device components when the device is mounted on cartridge 10 and the latter is outside a printer. When cartridge 10 is introduced into a cartridge holder such as holder 48 shown in FIG. 6, bottom wall 85 of slide component 64 engages the upper edge of wall 54 of the cartridge holder whereby, as the cartridge is fully inserted into the holder, the slide component is displaced upwardly relative to the base component to displace boss 88 of the slide away from boss 90 of the base against the bias of spring 66 to open tubing 14 to the flow of ink therethrough. Similarly, when the cartridge is removed from the holder, slide wall 85 disengages holder wall 54 and spring 66 biases slide 64 downwardly relative to base 62 for bosses 88 and 90 to again pinch tube 14 therebetween to close the latter to the flow of ink therethrough.

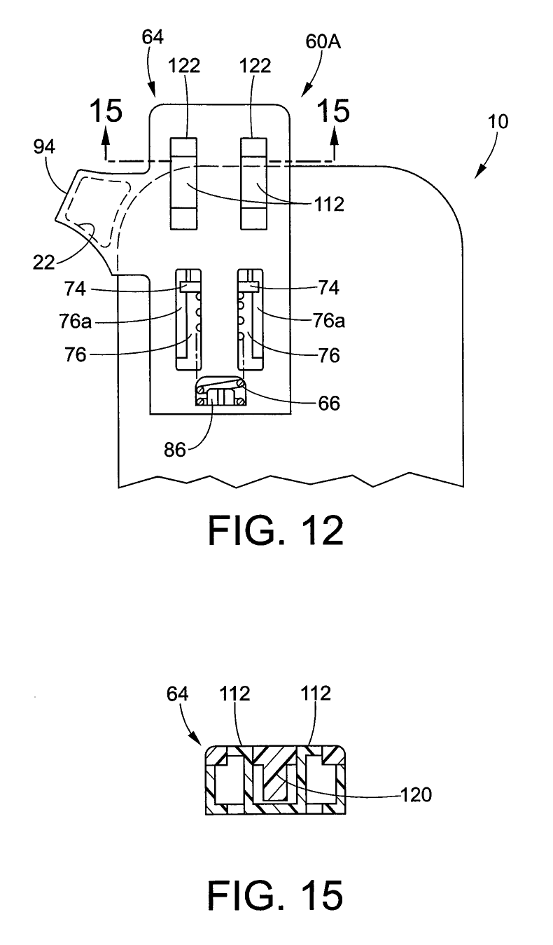

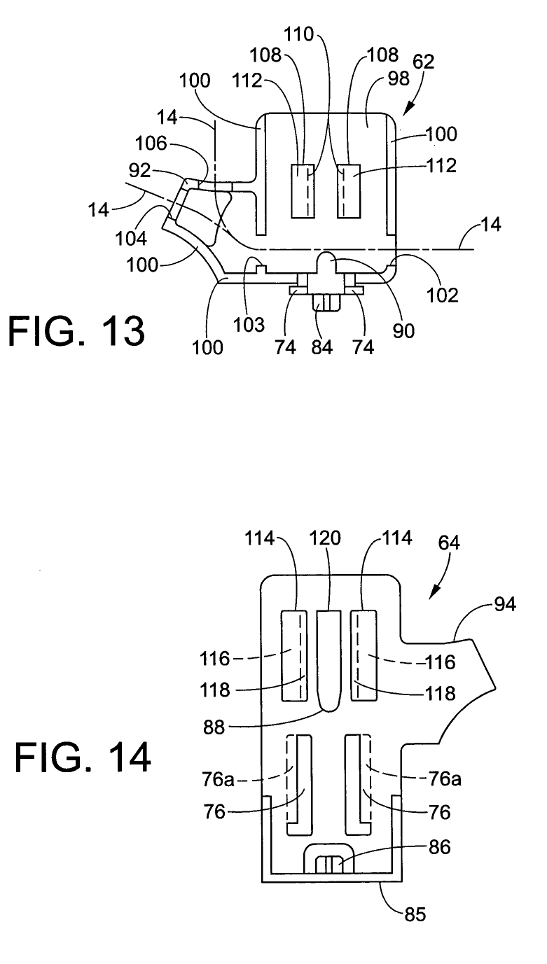

FIGS. 12-15 illustrate a modification of the embodiment shown in FIGS. 7-11 which advantageously eliminates the use of screws 78 for maintaining the base and slide components in assembled relationship. Accordingly, with the exception of the referenced modification, the component parts which correspond to those shown in FIGS. 7-11 are designated by like numerals in FIGS. 12-15. In this embodiment, the base and slide components of the clamping device, which is designated 60A, are modified to provide for an interengagement in the upper area thereof which enables relative sliding displacement vertically while precluding separation of the components transverse to the direction of sliding. More particularly in this respect, bars 68 and slots 80 of base 62 are replaced by L-shaped retaining members 108, each of which includes an inner leg 110 extending upwardly from wall 98 and a leg 112 spaced above wall 98 and extending outwardly from leg 110. Further, in this respect, bars 70 and mounting post 82 on the inner side of slide 64 are replaced by a pair of L-shaped retaining members 114, each of which includes an outer leg 116 extending upwardly from the inner side of the slide and an upper leg 118 spaced above the inner side of the slide and extending inwardly from leg 116. A rib 120 is provided between retaining members 114, and the lower end of the rib is rounded to provide boss 88. The base and slide components are assembled by introducing fingers 74 through the enlarged lower ends of slots 76, displacing the base and slide into parallel relationship, sliding the components relative to one another to slidably interengage retaining members 108 and 114, and mounting spring 66 between posts 84 and 86 to bias the slide downwardly relative to base 62. It will be appreciated that the sliding interengagement between retaining members 108 and 114 provide for legs 112 of the retainers on base 62 to overlie legs 118 of the retainers on slide 64. Legs 112 of retaining members 108, and thus the relative positions between the base and slide components, are visible through windows 122 in the slide which underlie retaining members 114 on the slide. A further modification is provided by relocating opening 104 in base 62 from the lower portion of extension 92 to the outer end thereof.

As will be appreciated from the embodiment described in connection with FIGS. 7-11, when clamping device 60a is mounted on a cartridge 10 as shown in FIG. 12, the cartridge is outside a printer and spring 86 biases a slide downwardly relative to base 62 for bosses 88 and 90 to pinch tube 14 therebetween to close the latter to the flow of ink therethrough. As will be further appreciated from the description with regard to FIG. 7, when cartridge 10 with clamping device 60a is inserted into a cartridge holder 48, bottom wall 85 of the slide engages wall 54 of the holder and as the cartridge is fully seated in the holder, slide 64 is displaced upwardly relative to base 62 to displace bosses 88 and 90 away from one another to open tube 14 for the flow of ink therethrough. Upon removal of the cartridge from the holder, slide 64 is really displaced from wall 54 of the holder, whereupon spring 86 biases the slide downwardly relative to base 62 to again cause tube 14 to be pinched between bosses 88 and 90.

As will be appreciated from the foregoing description of the preferred embodiments, the spring force must be sufficient to crimp the tubing so as to assure against leakage of ink through the tubing when the cartridge is outside the printer. Since the cartridge is typically held in the cartridge holder by an over center or detent action type spring, the reaction force from the clamping spring may require that the holding force be increased which, in turn, would lead to higher insertion and removal forces for the operator. Accordingly, it is desirable to minimize the force required to crimp the tubing so as to minimize the affect on the detent holding force between the cartridge and cartridge holder. In accordance with another aspect of the present invention, this is achieved by using compliant, low durometer tubing which collapses easily when crimped. Preferably, 50 durometer silicone tubing is used to optimize the desired crimping action with minimum clamping spring force, although PVC or vinyl tubing having durometer values in the range of 65-70 can be used. An additional advantage of the silicone tubing is that it can be crimped for long periods of time with a minimum likelihood that the tubing would take a set from the crimping action.

While considerable emphasis has been placed herein on the structures and structural interrelationships between the component parts of preferred embodiments of the invention, it will be appreciated that other embodiments can be devised and that many changes can be made in the preferred embodiments without departing from the principals of the invention. Therefore, it is to be distinctly understood that the foregoing descriptive matter is to be interpreted merely as illustrative of the invention and not as a limitation and that it is intended to include other embodiments and all modifications of the preferred embodiments insofar as they come within the scope of the appended claims or the equivalents thereof.

Having thus described the invention, it is so claimed:

1. A clamping device for an ink cartridge for opening and closing an ink supply tube for supplying ink to the cartridge from a remote source, comprising a first clamping member fixed relative to the ink cartridge, a second clamping member displaceable relative to the first member between clamping and unclamping positions, relative thereto, said first and second clamping members being adapted to receive an ink supply tube therebetween, and said first and second members in said clamping and unclamping positions respectively closing and opening a supply tube therebetween to the flow of ink therethrough.

2. A clamping device according to claim 1, and biasing means biasing said second clamping member toward said clamping position.

3. A clamping device according to claim 1, wherein said first and second clamping members are mountable on an ink cartridge as a unit.

4. A clamping device according to claim 1, wherein said first clamping member is attached to the cartridge and said second clamping member is supported on the cartridge for displacement relative thereto.

5. A clamping device according to claim 1, wherein the cartridge has a handle and one of said first and second clamping members includes a mounting member interengageable with said handle for mounting the clamping device on the cartridge.

6. A clamping device according to claim 5, wherein said first clamping member includes said mounting member and said cartridge has front and rear ends, said second clamping member being interengaged with said first clamping member for sliding displacement in the direction between said front and rear ends.

7. A clamping device according to claim 6, and biasing means biasing said second clamping member toward said clamping position.

8. A clamping device according to claim 6, wherein said first and second clamping members are laterally adjacent one another and in alignment in the direction between said front and rear ends when said second clamping member is in said unclamping position.

9. A clamping device according to claim 8, and biasing means biasing said second clamping member toward said clamping position.

10. A clamping device according to claim 9, wherein said second clamping member is rearwardly of said first clamping member in said unclamping position.

11. A clamping device according to claim 5, wherein said first clamping member includes said mounting member and said cartridge has top and bottom ends, said second clamping member being interengaged with said first clamping member for sliding displacement in the direction between said top and bottom ends.

12. A clamping device according to claim 11, and biasing means biasing said second clamping member toward said clamping position.

13. A clamping device according to claim 11, wherein said second clamping member is slidably mounted on said first clamping member.

14. A clamping device according to claim 13, and biasing means biasing said second clamping member toward said clamping position.

15. An ink cartridge for insertion into a cartridge holder, said cartridge having a coupling for an ink supply tube to be coupled therewith for delivering ink to the cartridge from a remote source, and clamping means on said cartridge for closing and opening a supply tube to control the flow of ink from said source to said cartridge.

16. The ink cartridge according to claim 15, wherein said clamping means includes a clamping member slidably mounted on said cartridge and engageable with a cartridge holder to open a supply tube when said cartridge is introduced into said holder.

17. The ink cartridge according to claim 16, and means biasing said clamping member to close the supply tube when said cartridge is removed from the holder.

18. The ink cartridge according to claim 15, wherein said cartridge has a side, front and rear ends, the supply tube having a portion extending downwardly along said side, and said clamping member being displaceable in the direction between said front and rear ends to open and close the supply tube.

19. The ink cartridge according to claim 15, wherein said cartridge has a side, front and rear ends, and top and bottom ends, the supply tube having a portion extending along said side in the direction between said front and rear ends, and said clamping member being displaceable in the direction between said top and bottom ends to open and close the supply tube.

20. The ink cartridge according to claim 15, wherein said clamping means includes a first clamping member fixed relative to said cartridge and a second clamping member supported on said cartridge for sliding displacement relative to said first member, said second clamping member being engageable with a cartridge holder for opening the supply tube when the cartridge is introduced into the holder.

21. The ink cartridge according to claim 20, wherein the cartridge has a handle and one of said first and second clamping members includes a mounting member interengageable with said handle for mounting the clamping means on the cartridge.

22. The ink cartridge according to claim 21, wherein said first clamping member includes said mounting member and said cartridge has front and rear ends, said handle being at said rear end, and said second clamping member being interengaged with said first clamping member for sliding displacement in the direction between said front and rear end.

23. The ink cartridge according to claim 22, and biasing means biasing said second clamping member toward said clamping position.

24. The ink cartridge according to claim 21, wherein said cartridge has top and bottom ends, said first clamping member including said mounting member, and said second clamping member being interengaged with said first clamping member for sliding displacement in the direction between said top and bottom ends.

25. The ink cartridge according to claim 24, biasing means biasing said second clamping member toward said clamping position.

26. The ink cartridge according to claim 25, wherein said second clamping member is vertically above said first clamping member.

27. An ink cartridge for insertion into a cartridge holder and having an ink supply tube coupled therewith for delivering ink to the cartridge from a remote source, and clamping means on said cartridge for closing and opening the supply tube to control the flow of ink from said source to said cartridge.

28. An ink cartridge according to claim 27, wherein said ink supply tube has a durometer hardness of between 65 and 70.

29. An ink cartridge according to claim 27, wherein said supply tube has a durometer hardness of 50.

30. An ink cartridge according to claim 29, wherein said supply tube is silicon tubing.

31. A clamping device for controlling the flow of ink through a supply tube to an ink jet cartridge, said clamping device including a base attachable to an ink cartridge, a slide on said base and slidable relative thereto between clamping and unclamping positions, and a spring biasing said slide toward said clamping position.

32. A clamping device according to claim 31, wherein said base includes a protrusion for mounting interengagement with a handle of an ink cartridge.

33. A clamping device according to claim 31, wherein said base and slide include openings therebetween for selectively routing an ink delivery tube through the clamping device.

34. A clamping device according to claim 31, wherein said base is attachable to an ink cartridge having front and rear ends for said slide to be displaceable in the direction between the front and rear ends.

35. A clamping device according to claim 34, wherein said base includes a protrusion for mounting interengagement with a handle of an ink cartridge.

36. A clamping device according to claim 35, wherein said base and slide include openings therebetween for selectively routing an ink delivery tube through the clamping device.

37. A clamping device according to claim 31, wherein said base is attachable to an ink cartridge having top and bottom ends for said slide to be displaceable in the direction between said top and bottom ends.

38. A clamping device according to claim 37, wherein said base includes a protrusion for mounting interengagement with a handle of an ink cartridge.

39. A clamping device according to claim 38, wherein said base and slide include openings therebetween for selectively routing an ink delivery tube through the clamping device.
